(19) United States
(12) Patent Application Publication
(10) Pub. No.: US 2012/0078964 A1
(43) Pub. Date: Mar. 29, 2012

(54) SYSTEM FOR STORING AND DISEMINATING PATIENT DATA AND RELATED INFORMATION

(76) Inventor: David HOLD, Aventura, FL (US)

(21) Appl. No.: 13/075,712

(22) Filed: Mar. 30, 2011

Related U.S. Application Data
(60) Provisional application No. 61/318,822, filed on Mar. 30, 2010.
(60) Provisional application No. 61/370,862, filed on Aug. 5, 2010.

(51) Int. Cl. G06F 12/14; G06F 17/30

(52) U.S. Cl. 707/784; 707/E17.008

(57) ABSTRACT

The system described has many advantages and provides safeguards for the patients. More specifically, if some information from any source is suspect or potentially dangerous, the primary health care provider and/or other entities such as local emergency services are notified in real time.

### RELATED APPLICATIONS

This application claims priority to U.S. provisional application 61/318,822 filed Mar. 30, 2010, incorporated herein by reference in its entirety. The subject matter of this application is also related to the subject matter of commonly owned co-pending application Ser. No. 13/004,267 filed Jan. 11, 2011 claiming priority to U.S. 61/294,165 filed Jan. 12, 2010 and to application Ser. No. 13/033,116 filed Feb. 24, 2011, claiming priority Ser. No. 61/370,862 filed Aug. 5, 2010, both incorporated herein by reference in their entirety.

### BACKGROUND OF THE INVENTION

A. Field of Invention

This invention pertains to a method and system of storing patient data in a master data storage or vault wherein the data can be stored, modified or retrieved only on approval by an authorized health care provider.

B. Description of the Prior Art

During the last half century, the science of medicine has made great strides in developing new procedures, new drugs and new devices that address a large variety of medical problems. As a result people live longer and their quality of life has improved to levels that seemed impossible not too long ago. However, the task of record keeping associated with various medical events, from a simple visit, to complex hospital procedures, has remained in the dark ages. Recently it has been recognized by the medical community, various governmental agencies and other related entities that this problem affects not only the level of care that patients receive but also the various payments from patients, and/or other organizations, such as health insurance plans, to the health care providers. Moreover, the poor state of medical records has serious impact on many other issues, such as the doctor-patient relationship and the rights of privacy of patients.

Considerable, multi-disciplinary efforts have been made to correct the problem. The latest proposed solution to the problem consists of a universal record keeping system frequently referred to as the EMR (Electronic Medical Records) system. The promulgators hope that such a system would resolve the problems discussed above. However, it is believed that, as presently proposed, the various types of EMR could be error prone, therefore would not be acceptable to the medical community because they do not provide sufficient checks and balances.

### SUMMARY OF THE INVENTION

A patient data vault is provided that is used to store a separate patient record for each patient. The system is configured to perform two kinds of operation. One kind of operation involves either entering patient information into a patient's record or modifying the information in the patient record. During this operation, patient data from various sources, describing a patient encounter or other event, such as the need for the renewal of a drug or failure of a patient to take a drug may potentially all be stored in the patient record. A gate keeper is provided that includes a data buffer that includes a memory In this memory, rules, lists, and other information are stored defining what information can be entered into the patient record, what sources of patient information can provide information that is entered into the patient record, in some instances, ranges for certain data that are accepted. During this process, if some of the data to be entered meets certain criteria, alerts are generated to the primary patient care provider, and/or others who have a need to know this information, such as a custodian for the patient, etc. The data ranges, as well as the criteria, rules, lists, etc., are preferably provided by the primary health care provider. If the data is within an acceptable range and/or an acceptable source, it is entered into the patient record. In some instances the primary health care provider is also notified of the information.

The second process involves retrieving information from the patient record. Various entities may need information from the patient records for various reasons, including performing a procedure on the patient, checking the status of the patient, generating billing for patient encounters, statistical data for drug manufacturers, etc. An entity, such as a drug store, a hospital or an HMO generates a request that is sent to the gate keeper. The gate keeper checks its lists and other information to determine if the requester is allowed or authorized to receive the information, and then either retrieves the information and sends it to the party or provides an authorization code that is then used by the requester to obtain the information.

### BRIEF DESCRIPTION OF THE DRAWINGS

FIG. 1 shows a block diagram of the elements of a system constructed in accordance with this invention;

FIG. 2 shows an embodiment for the gatekeeper; and

FIG. 3 shows details of the buffer module for the gatekeeper.

### DETAILED DESCRIPTION OF THE INVENTION

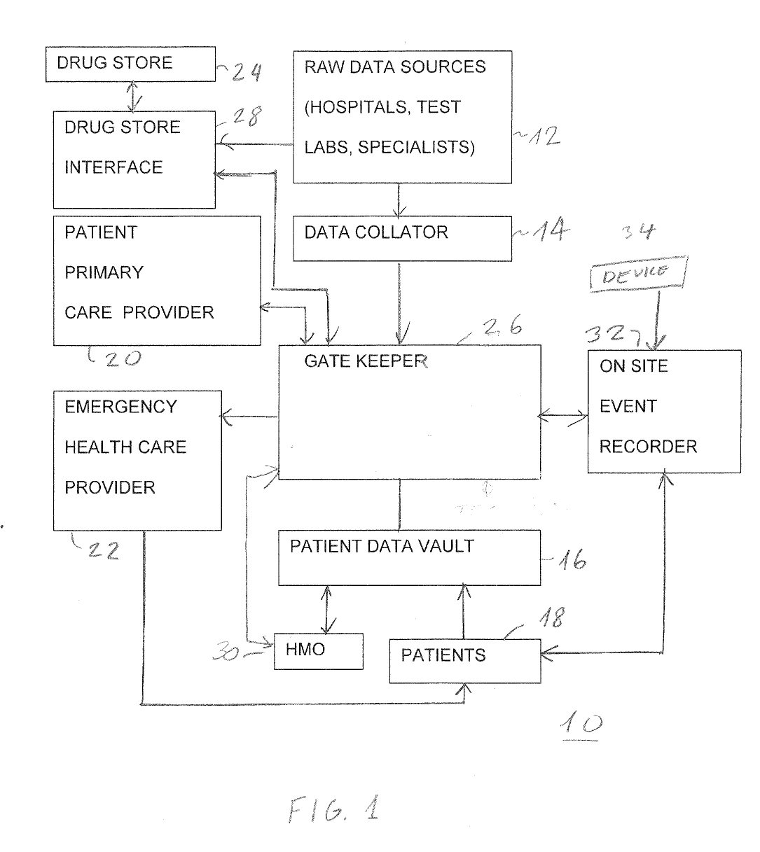

The present invention provides an improved system which provides safeguards that insure that errors are eliminated. A block diagram of a system 10 implementing the subject invention is shown in FIG. 1. In this Figure, raw data from several sources relevant to patients are generated by including hospitals, labs, test sites, special care providers 12 etc. This data is collected and aggregated as necessary by a data collator system 14. Collator systems of this type are available from Microsoft under the name of Amalga Unified Intelligence System, and others.

The collator system 14 makes the collected information available in various formats to various entities, such as health care plans, various local, national or international health organizations, universities and other health related research centers. Of course, the information provided to each of these entities takes on different formats and contains data at various levels of granularity and patient specificity. For example, health organizations may be interested in how many patients have undergone an MRI test. This data may be presented in the form of tables or graphs using various parameters relating the patients to age, sex, national origin, genetic characteristics, geographic area, etc. However, this data does not include any information that could be used to identify specific patients.

Data from the collator system 14 is also provided to a national data bank which is used as a repository, or a patient data vault 16 for patient specific data. This data bank includes a record for each patient 18. Because this data is very patient-specific, very high level safe guards are provided so that this data is protected from external attacks to protect the patients' privacy. Every time a patient 18 has a health related encounter, the data from this encounter is entered into the data bank and the patient's record is updated. (An encounter is any event that involves the patient's health and may include a visit to the patient's primary health care provider 20, a visit to an emergency health care provider 22, a drug store 24, as well as a hospital, lab, or specialist 12)

Patient specific data may also be provided to health care providers who handle particular patients, such as primary physicians 20 and emergency health care providers 22.

In accordance with this invention, the present system further includes a gate keeper 26 that controls the data flow from the data collator 14 to the data bank 16. The gate keeper 26 is primarily composed of an automated data module but may include a module that requires human input as well. The operation of this gate keeper is described in more detail below.

Advantageously, other components may be added to the system that further improve its utility. One such component is a drug store or pharmacy interface 28. This drug interface is coupled to any entity that provides drug prescriptions to the patient 18, including the primary health care provider 20, the hospital, specialists 12, etc. In one embodiment of the invention, the drug store interface 28 receives a prescription for a patient including the patient ID, the drug being prescribed and instructions on when and how the drug is to be taken. The interface 28 transmits this information to a participating drug store 24 which then delivers the drug to the patient 18 with appropriate instructions. The drug store interface 28 also provides the relevant data to the data collator 14 system and, in essence, it becomes a data source itself.

In another embodiment of the invention, the drug store interface 28 remains an active participant even after the drug delivery. More specifically, the drug interface 28 checks with the drug store that the prescribed drug has been delivered to the appropriate patient 18. Thereafter, it contacts the patient 18 at regular intervals and checks with the patient 18 that the drug has been taken at appropriate times. The interface/patient communication can be implemented on line, e.g., the patient may be requested to respond to questions regarding the drug every time he gets on line, by e-mail requesting responses, by voice messages via land-line, or cellular telephones, etc.

The information collected from the patient 18 is then provided to the drug store 24, the health care provider 20, and other interested parties either directly, or through the data collator 14.

The drug store interface module 28 also monitors the drug supply of the patients 18 and when the supply is getting low, it alerts the care provider 20 and/or drug store 24 that a new subscription is required and/or offers to the patient to have the prescription renewed.

The drug store interface 28 module further negotiates with the appropriate health management organization (HMO) 30. The HMO 30 provides payment for the drug delivered to the patient and obtains payment for any deductible amounts from the patient 18, using a credit card or other suitable means. Of course, the drug store interface module 28 also handles other medical accessories as required by the patient 18 (e.g., neck braces, walkers, etc.) Details of the drug store interlace and how it operates are found in the above-mentioned commonly owned co-pending application Ser. No. 13/004,267.

Another component of the system is an on-site recorder 32. This recorder interfaces with, or receives information from patient 18 and/or a local device 34 used to detect or measure specific parameters related to the patient. The exact devices and parameters being measured vary from patient to patient and depend on the respective diagnoses associated therewith. Some of the parameters recorded can include the weight, blood oxygenation levels, blood sugar level, EKG, EEG, respiration rate, heart rate, etc. These parameters are then transmitted either automatically or on demand to a remote location, in this case, gatekeeper 26 for analysis. Details of a system for monitoring a patient's glucose level are found in commonly owned co-pending application Ser. No. 13/033,116 identified above.

Advantageously, in the present invention, the parameters from the on-site recorder 32 are sent essentially in real time to the gatekeeper 26 using any conventional means. At the gatekeeper 26 each patient parameter received from the event recorder 32 is reviewed. In one embodiment, this review is performed automatically and it entails comparing the parameter to threshold levels or other criteria for that parameters set, for example, by the primary care provider 20, or by another entity. If the parameter fails to meet certain safety criteria, the gatekeeper 26 sends an appropriate alert signal to the primary health care provider 20 and/or an emergency health care provider 22 (e.g, a local emergency room in a local hospital). The health care provider 20, 22 can either contact the patient 18, or in extreme cases, an ambulance may be dispatched.

In an alternate embodiment, parameters from a patient are sent to a technician. The technician uses his know how, experience and preset protocols to analyze each parameter. If it is not already available, the technician can access additional patient information (e.g., past history) from the patient data vault to make a prognosis of whether the parameter needs to be only recorded or further action is necessary, based on several levels of severity as determined by the preset protocols. For example, the further action may include generating a flag to indicate that the patient needs to be watched carefully, or the tests needs to be repeated more frequently, send an alert to the primary physician and/or the specialist, call the patient, call emergency services, etc. These manual inputs from the technician are collected by the gate keeper 26 and any flags, or alerts set or requested by the technician are sent on to the appropriate health care provider as discussed.

Of course all the data collected by the on-site recorder may also be added to the patient record in the data bank.

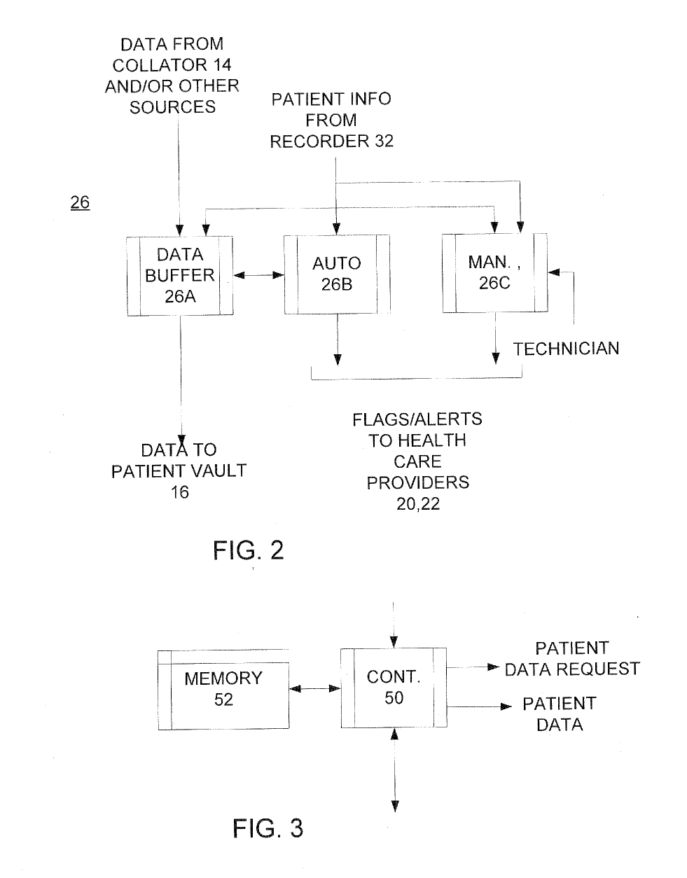

The gatekeeper 26 can be a single unit or it can include several modules, each module operating independently. For example, as shown in FIG. 2, the gate keeper 26 may include several modules. One of the modules is a data buffer 26A. This module receives patient data from the collator 14 and other sources and, when authorized provides it to the patient data vault 16. Another module is the automated module 26B that receives that from recorder 32 and analyzes it automatically as discussed above. Another module is the manual module 26C that receives data from the recorder 32, presents it to one or more technicians, receives manual inputs from the technicians and provides outputs to the health care providers as discussed. Both modules 26B, 26C can also send and receive patient information to and from the vault through the buffer 26A. Modules 26B and 26C are optional for the purposes of this invention.

As described above, buffer 26A receives and reviews all the information being transmitted by the data collator system for the secure patient vault. As shown in FIG. 3, the buffer 26A may be implemented as a controller 50, and a memory 52. The memory 52 is used to store a predetermined set of rules, protocols, tables, as well as various patient ID information and correlating information indicating who has permissions and/or is authorized to get access to, or to modify the record some or all the patients. The memory 52 is used by controller 50 to determine if (1) patient data from a particular source is acceptable or not; and (2) whether the source for the data is authorized to store the patient information into the patient record stored in the vault. It is expected that in most cases the information will be acceptable and if it is acceptable, it is passed on to the secure patient vault.

However, in some instances, the information will indicate an abnormality. In this case, an alert is generated to the automated or manned module where the suspect information is reviewed. If the modules are missing then the controller 50 analyses the suspect information. Since the information may be related to any one of many different kinds of health problems, different technicians may be provided with special training for each type of health problem, each interfacing with module 26C. The respective technician then reviews the suspect information, obtains additional information about the patient as necessary, and determines whether any further action or intervention is necessary as described above. Optionally, if the suspect information is outside the range of some expected values or parameters, the automated component may generate an alert in real time to various entities, including local emergency services, the health provider, etc., without waiting for the technician.

In one embodiment of the invention, the primary health care provider 20 is fully involved in all data being recorded for his patients. For this purpose, the health care provider 20 provides a set of rules that are stored in memory 52 indicating what information does the patient primary health care provider 20 needs to see before it is entered into the patient record, who is allowed to add or change information entered into the record, who is allowed to access the record, etc.

In one embodiment, the health care provider is alerted to every data entry related to every encounter with the patient, whether the primary health care provider was involved with the encounter at all, or not. In this manner, if a patient decides to visit three different cardiologist and gets three different opinion about his health, the primary health care provider is so informed.

The primary health care provider 20 can also set certain limits for certain test results, whether they are obtained by on-site device 32 or some other source, e.g, a test lap 12. If the test results are within acceptable level, the provider 20 can select the rules in memory 52 so that the test results are automatically entered into the patient record in the vault. If some test results are abnormal, the health care provider can elect to be alerted either automatically or by the module 26B or 26C. Once the health care provider receives a report of an abnormal report, he may let it be entered without further action, or, more likely, he alerts the patient 18 and request that the patient come in or, severe conditions, go to an emergency room ASAP.

In one embodiment of the invention, when an extreme report is detected (e.g. a report with extreme values for certain predetermined parameters), a primary care provider can request to be contacted immediately. If the provider is not found or is unavailable, the rules may require the gate keeper to seek emergency help for the patient in the form of an emergency health care provider. This action can be implemented either through the manual or automated modules 26C, 26B or through a separate emergency health care agency. Different health care agency personnel may be provided for different kinds of major disciplines, such as cardiac, pulmonary etc. These centers can be manned by physicians, nurses with appropriate experience and training, etc. Of course, encounters between personnel of an emergency agency and the patient are similarly recorded and presented to the primary health care provider.

The techniques described above are also applicable to the drug store interface 28. The drug store interface 28 looks for and monitors every prescription provided to a patient and provides this information to the pharmacy so that the latter can properly detect when possible conflict can occur between drugs prescribed to the patient by different doctors. All this information is also entered into the patient record.

The operation of the system shown in the Figures can be summarized as follows. A patient data vault 16 is provided that is used to store a separate patient record for each patient. The system is configured to perform two kinds of operation. One kind of operation involves either entering patient information into a patient's record or modifying the information in the patient record. During this operation, patient data from various sources, describing a patient encounter or other event, such as the need for the renewal of a drug or failure of a patient to take a drug may potentially all be stored in the patient record. The gatekeeper 26 includes a data buffer 26A that includes a memory 52. In this memory, rules, lists, and other information are stored defining what information can be entered into the patient record, what sources of patient information can provide information that is entered into the patient record, in some instances, ranges for certain data that are accepted. During this process, if some of the data to be entered meets certain criteria, alerts are generated to the primary patient care provider, and/or others who have a need to know this information, such as a custodian for the patient, etc. The data ranges, as well as the criteria, rules, lists, etc., are preferably provided by the primary health care provider 20. If the data is within an acceptable range and/or an acceptable source, it is entered into the patient record. In some instances the primary health care provider is also notified of the information.

The second process involves retrieving information from the patient record. Various entities may need information from the patient records for various reasons, including performing a procedure on the patient, checking the status of the patient, generating billing for patient encounters, statistical data for drug manufacturers, etc. An entity, such as a drug store 24, a hospital 12 or an HMO generates a request that is sent to the gate keeper 26. The gate keeper 26 checks its lists and other information to determine if the requester is allowed or authorized to receive the information, and then either retrieves the information and sends it to the party or provides an authorization code that is then used by the requester to obtain the information.

In some instances, the request information is patient specific. In other instances, it may be statistical in nature without the patient specific information.

Numerous modifications can be made to this invention without departing from its scope as defined in the appended claims.

I claim:

1. A method of controlling and retrieving patient information from a patient data vault, using an automated gate keeper comprising:
receiving a request for information by a requester;
determining by said gate keeper if said requester is authorized to receive said information; and
releasing said information if said requester is authorized.

2. The method of claim 1 wherein gate keeper includes a memory listing authorized requesters, said gatekeeper determining if said requester is on said list before releasing said information.

3. The method of claim 1 further comprising:
Presenting to said gatekeeper information to be stored in said patient data vault;
Determining if said information is allowed to be stored based on data in said memory; and
Storing said information in said vault if so authorized.

4. The method of claim 3 wherein said determination is made of a value of a parameter contained in said information.

5. The method of claim 3 wherein said determination is made based on the source for said information.

6. The method of claim 1 wherein said patient is associated with a primary care provider and wherein said determination is made based on rules set by said primary health care provider.
